(19) United States
(12) Patent Application Publication
(10) Pub. No.: US 2018/0053441 A1
(43) Pub. Date: Feb. 22, 2018

(54) DEMONSTRATION AND TRAINING MODEL

(71) Applicant: Boston Scientific Scimed, Inc., Maple Grove, MN (US)

(72) Inventors: Jozef SLANDA, Milford, MA (US); Adam MELNICK, Newton, MA (US); Manuel B. TEIXEIRA, Boston, MA (US)

(73) Assignee: Boston Scientific Scimed, Inc., Maple Grove, MN (US)

(21) Appl. No.: 15/680,790

(22) Filed: Aug. 18, 2017

Related U.S. Application Data
(60) Provisional application No. 62/377,365, filed on Aug. 19, 2016.

(51) Int. Cl. G09B 23/34; G09B 9/00

(52) U.S. Cl. CPC G09B 23/34; G09B 9/00

(57) ABSTRACT

A medical device may include an elastomeric block having internal structures. The internal structures may include a simulated kidney and at least one accessway extending from an external surface of the elastomeric block to the simulated kidney.

### CROSS-REFERENCE TO RELATED APPLICATIONS

This application claims the benefit of priority to U.S. Provisional Application No. 62/377,365, filed Aug. 19, 2016, which is incorporated by reference herein in its entirety.

### TECHNICAL FIELD

Various aspects of the present disclosure relate generally to systems and methods useful in demonstrating and/or training for medical procedures. More specifically, the present disclosure relates to training devices, systems, and methods for urological procedures.

### BACKGROUND

Many medical procedures that once required open surgery can now be done with less invasive techniques that limit the size of incision, thus reducing recovery time and risk of infection. In the field of urology, for example, renal calculi or kidney stones can accumulate in the urinary tract and become lodged in the kidney. Kidney stones are deposits of materials from urine, typically minerals and acid salts. While smaller stones may pass from the body naturally, larger stones may require surgical intervention for removal. Although open surgery was once the standard treatment for the removal of stones, other less invasive techniques, such as ureteroscopy and percutaneous nephrolithotomy or nephrolithotripsy (hereinafter “PCNL”), have emerged as safer, effective alternatives. Yet, procedures such as PCNL still carry risks as the physician only has a limited view of the treatment site. The kidneys are surrounded by other internal organs, blood vessels, and tissue that the physician must avoid during surgery to prevent hemorrhage, infection, and fluid leakage. Medical personnel who do not routinely perform PCNL procedures or are inexperienced may be anxious at the possibility of injury to the patient due to an inability to locate the kidney and the stone. Moreover, repeated attempts to locate the stone in the kidney, grasp the stone, and remove the stone may lengthen the surgery and expose the patient to greater risks.

The devices and methods of the current disclosure may rectify some of the deficiencies described above or address other aspects of the prior art.

### SUMMARY

Examples of the present disclosure relate to, among other things, medical retrieval demonstration and training devices and methods. Each of the examples disclosed herein may include one or more of the features described in connection with any of the other disclosed examples.

In one example, a medical training model may include an elastomeric block having internal structures, the internal structures including a simulated kidney, and at least one accessway extending from an external surface of the elastomeric block to the simulated kidney.

Examples of the medical training model may additionally include any one or more of the following features. The simulated kidney may include a renal pelvis, calyces, and lower, middle, and upper kidney poles. The internal structures may further include a simulated ureter. The internal structures may further include a simulated stone. The simulated kidney may be completely enclosed within the elastomeric block. The simulated kidney may be open to a front face of the elastomeric block. The medical training model may further include an angled block support receiving the elastomeric block in a tilted orientation, and the tilted orientation may be approximately 30 degrees from horizontal. The medical training model may further include a liquid-tight container receiving the elastomeric block. The medical training model may further include an angled block support receiving the elastomeric block in a tilted orientation and a liquid-tight container that receives the elastomeric block on the angled block support. The medical training model may further include a sheath extending outside the elastomeric block, into the at least one accessway, and to the simulated kidney. The elastomeric block may be formed of one of a casting resin, silicone, P-15 silicone, or a solid forming liquid molding formula. The at least one accessway may include at least three accessways, and the at least three accessways may extend from the external surface of the elastomeric block to at least a lower pole, a middle pole, and an upper pole of the simulated kidney. The elastomeric block may be a molded elastomeric block.

In another example, a medical training model may comprise an elastomeric block having internal structures, the internal structures including a simulated kidney; and a liquid-tight container receiving the elastomeric block in a tilted orientation.

Examples of the medical training model may additionally include any one or more of the following features. The medical training model may further comprise at least one accessway extending from an external surface of the elastomeric block to the simulated kidney. The medical training model may include a sheath extending outside the elastomeric block, into the at least one accessway, and to the simulated kidney. The tilted orientation of the medical training model may be approximately 30 degrees from horizontal.

In another example, a medical training method may comprise inserting a medical device into an internal structure formed in an elastomeric block, the internal structure including at least one of a simulated kidney or a simulated ureter; and locating a stone in the internal structure with the medical device.

Examples of the medical training method may additionally include any one or more of the following features. The medical training method may further include retrieving the stone from the internal structure. The medical training method may further include reintroducing a stone to the internal structure after retrieval. The medical training method may further include introducing a sheath from external to the elastomeric block to the internal structure, and wherein the inserting of the medical device includes inserting the medical device through the sheath. The internal structure may be filled with liquid, and the medical training method may further include applying energy to the stone. Locating the stone may include viewing the stone through the medical device.

Both the foregoing general description and the following detailed description are exemplary and explanatory only and are not restrictive of the features, as claimed. As used herein, the terms “comprises,” “comprising,” or other variations thereof, are intended to cover a non-exclusive inclusion such that a process, method, article, or apparatus that comprises a list of elements does not include only those elements, but may include other elements not expressly listed or inherent to such a process, method, article, or apparatus. Additionally, the term “exemplary” is used herein in the sense of “example,” rather than “ideal.”

### BRIEF DESCRIPTION OF THE DRAWINGS

The accompanying drawings, which are incorporated in and constitute a part of this specification, illustrate exemplary features of the present disclosure and together with the description, serve to explain the principles of the disclosure.

FIG. 1 illustrates an exemplary demonstration and training model.

FIG. 2 illustrates an exemplary renal calyx model that may be used to form the demonstration and training model of FIG. 1.

FIG. 3 illustrates a side view of the exemplary demonstration and training model of FIG. 1.

### DETAILED DESCRIPTION

Examples of the present disclosure relate to a medical demonstration and training model for percutaneous nephrolithotomy or nephrolithotripsy (hereinafter “PCNL”). The demonstration and training model may be used to instruct or simulate a medical professional's experience placing a renal sheath and performing a PCNL procedure.

Reference will now be made in detail to examples of the present disclosure described above and illustrated in the accompanying drawings. Wherever possible, the same reference numbers will be used throughout the drawings to refer to the same or like parts.

The terms “proximal” and “distal” are used herein to refer to the relative positions of the components of an exemplary surgical medical demonstration or training model. When used herein, “proximal” refers to a position relatively closer to an operator using the medical demonstration or training model or closer to the exterior of the simulated body or patient. In contrast, “distal” refers to a position relatively further away from the operator using the medical demonstration or training model, or closer to the interior of the simulated body or patient.

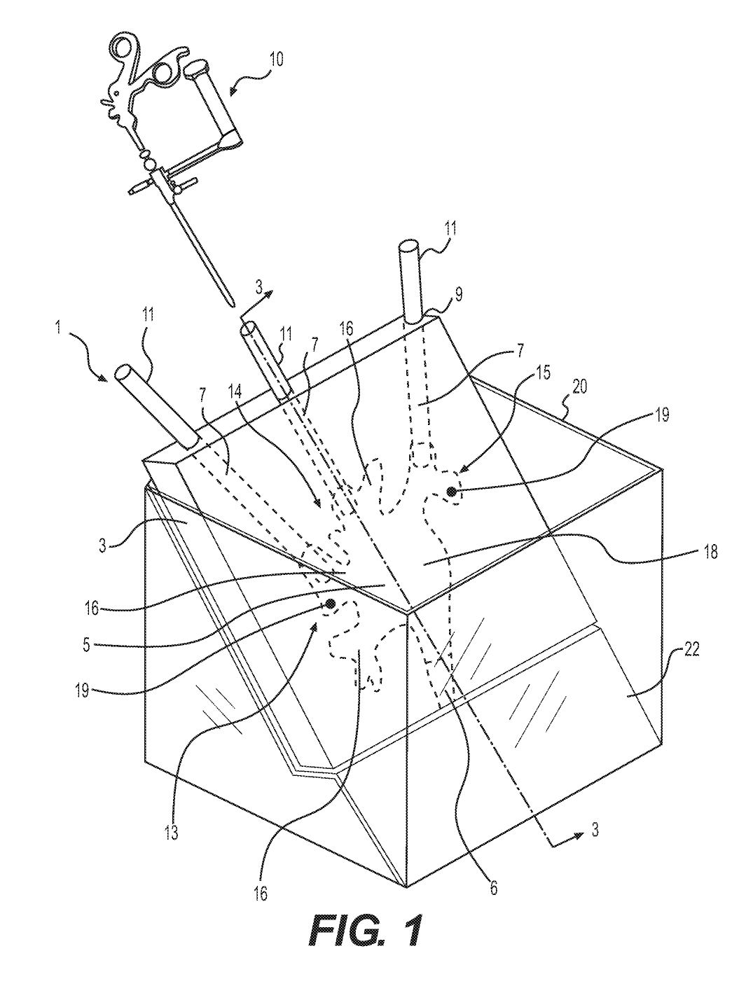

FIG. 1 illustrates an exemplary medical demonstration and training model 1 including an elastomeric block 3 comprising a simulated kidney 5 that represents the renal pelvis 18 and calyces 16 that make up the simulated kidney 5, with simulated ureter 6. The elastomeric block 3 includes at least one accessway 7 that, along with renal sheaths 11, provide access to a lower pole 13, a middle pole 14, and an upper pole 15 of simulated kidney 5 inside the elastomeric block 3 and connect to the exterior via ports 9. FIG. 1 also shows nephroscope 10 and setup container 20.

Elastomeric block 3 may be a solid parallelepiped or rectangular box shape, with hollow or empty sections that form the simulated kidney 5, simulated ureter 6, and at least one accessway 7. Elastomeric block 3 may be formed of any natural or synthetic polymer that may have elastic properties and may be molded or solidified around various mold elements to form the simulated kidney 5, and simulated ureter 6, and at least one accessway 7.

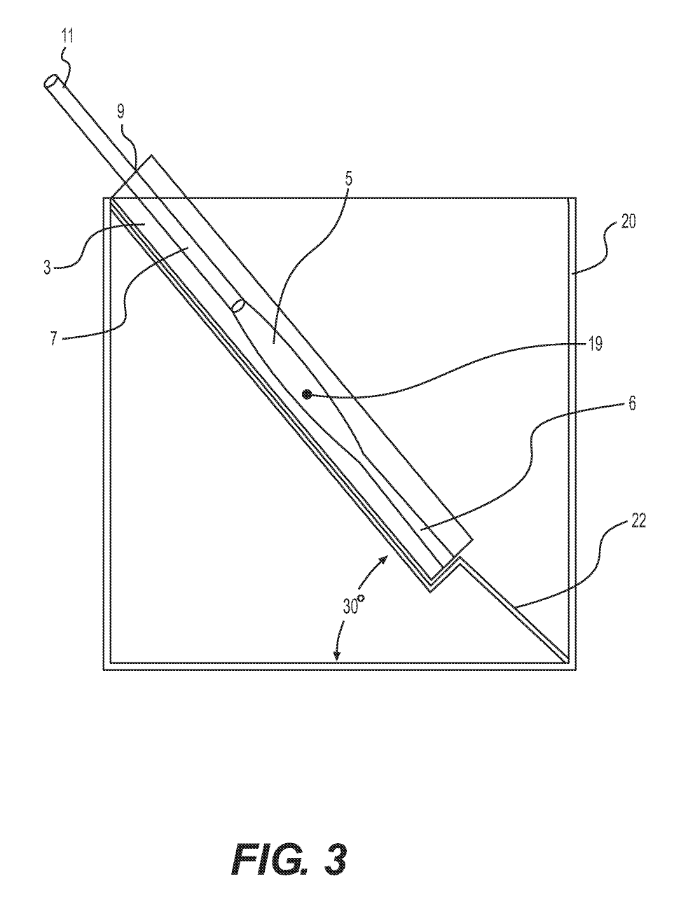

As shown in FIGS. 1 and 3, the elastomeric block 3 may be positioned in setup container 20. Setup container 20 may be a liquid-tight, transparent rectangular box with an open top. Setup container 20 may also be other suitable shapes such that it may contain and support elastomeric block 3. Elastomeric block 3 may be positioned at approximately a 30 degree angle with respect to the setup container 20 so as to replicate the angle at which a PCNL medical procedure would be performed relative to a patient in order to access a kidney. Elastomeric block 3 may also be positioned at other angles relative to the setup container 20 to mimic PCNL procedures at different angles. The positioning may be accomplished by an angled insert 22 placed within the setup container 20. Additionally, setup container 20 may comprise an angled or ledged bottom portion to support elastomeric block 3 at a desired angle without angled insert 22. Alternatively, elastomeric block 3 may be positioned on angled insert 22 alone without the use of setup container 20 while still allowing for the simulation of a PCNL procedure or of a kidney condition that would necessitate a PCNL procedure. The setup container 20 and angled insert 22 may be formed of, for example, acrylic glass or polyurethane.

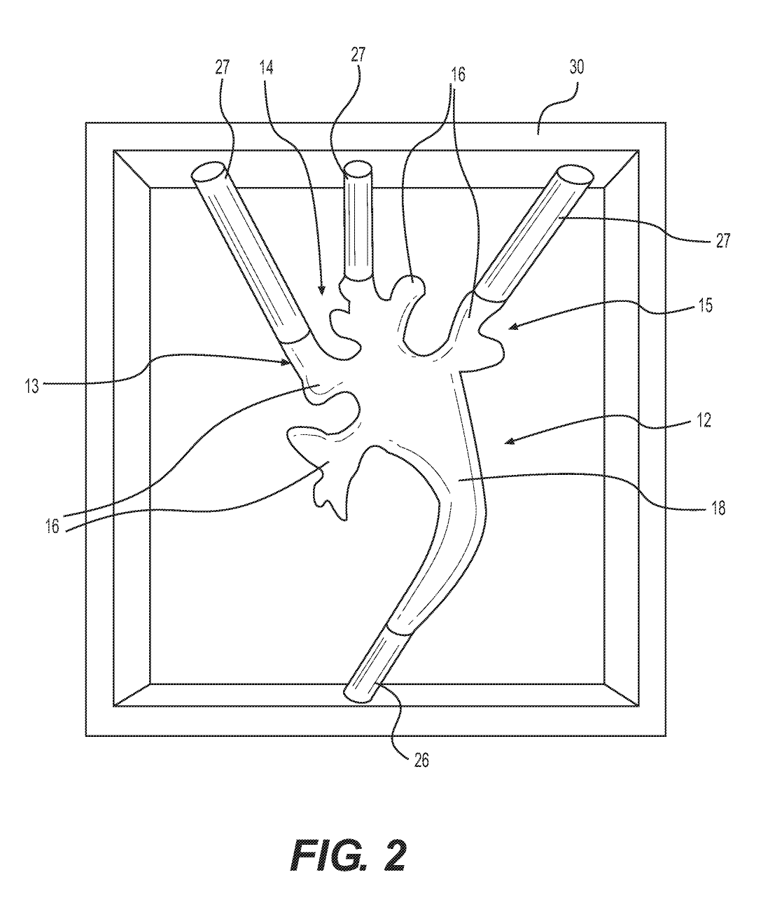

FIG. 2 illustrates an exemplary renal calyx model 12, a ureter model 26, and accessway models 27 in a rectangular mold frame 30. Renal calyx model 12 forms simulated kidney 5. Ureter model 26 forms simulated ureter 6, and accessway models 27 form accessways 7.

Renal calyx model 12 may be shaped to mirror the size and shape of the inner passageways of a human kidney with lower pole 13, middle pole 14, and upper pole 15, along with calyces 16 and a renal pelvis 18. Accessways 7 formed by accessway models 27 may allow renal sheath 11, nephroscope 10, and other instruments to be inserted in the elastomeric block 3. Accordingly, accessway models 27 may be an appropriate diameter such that the resulting accessways 7 may accept renal sheath 11, the nephroscope 10, and any other medical devices that may be inserted during a PCNL procedure. In one example, the accessway models 27 may be an appropriate size such that the resulting accessways 7 may be sized to accept a 30 French Gauge renal sheath for demonstrating proper sheath placement and facilitating use of the nephroscope 10 and other medical instruments. Ureter model 26 may be an appropriate diameter to allow nephroscope 10 and other instruments to be inserted into the resulting simulated ureter 6 after passing through accessways 7 and simulated kidney 5.

Renal calyx model 12, ureter model 26, and accessway models 27 may be formed of polyurethane or other similar materials. Mold frame 30 may be formed of a thermoplastic like polyoxymethylene, also known as trademark DELRIN®, or other similar materials.

According to one aspect of this invention, the elastomeric block 3 of the demonstration and training model 1 for a PCNL procedure may be formed by placing the renal calyx model 12, ureter model 26, and at least one accessway model 27 in mold frame 30. Then, casting resin, silicone, or any other solid forming liquid mold formula may be poured into the mold frame 30 and over the renal calyx model 12, ureter model 26, and accessway models 27. In one example, P-15 silicone may be used as the mold formula. Once the mold formula surrounds the renal calyx model 12, ureter model 26, and accessway models 27 and is level, the mold frame 30 may be allowed to solidify or be placed into a pressure vessel for an appropriate amount of time for the elastomeric block 3 to solidify. In one aspect, the mold frame 30 and elastomeric block 3 around the renal calyx model 12, ureter model 26, and accessway models 27 may be in the pressurized pressure vessel for 12 hours.

The mold frame 30 and elastomeric block 3 may be removed from the pressure vessel. The elastomeric block 3 with the enclosed renal calyx model 12, ureter model 26, and accessway model 27 may then be removed from the mold frame 30. Elastomeric block 3 may be cut with a blade or scalpel such that the renal calyx model 12, ureter model 26, and accessway models 27 may be removed from the elastomeric block 3. Backlighting may be used to assist in determining the location of the models in elastomeric block 3.

After the models are removed from elastomeric block 3, a kidney stone or multiple kidney stones 19 may be inserted into any part of the simulated kidney 5 in the elastomeric block 3 formed by removing the renal calyx model 12. In one aspect of the invention, the kidney stone or stones 19 may be placed in the calyces 16 or the renal pelvis 18. In another aspect of the invention, the kidney stone or stones 19 may be placed in the simulated ureter 6, which was formed by removing ureter model 26 from elastomeric block 3. The cut portion may then be pressed back into the elastomeric block 3 to enclose the at least one kidney stone 19. The cut portion may also be left open such that the locating, breaking up, and removing of the at least one kidney stone 19 may be observed from outside the elastomeric block 3 without a scope. Moreover, elastomeric block 3 may be cut, the models may be removed, and the at least one stone may be inserted into elastomeric block 3 while elastomeric block 3 is in mold frame 30, with elastomeric block 3 being separated from mold frame 30 after the at least one kidney stone is placed inside elastomeric block 3.

The elastomeric block 3, now separated from the mold frame 30 and enclosing at least one kidney stone 19, may then be placed into the setup container 20 on the angled insert 22. The setup container 20 may be filled with water or another appropriate solution to achieve the desired fill and pressure levels to mimic a PCNL procedure. The water or solution may permeate into the passageways of the simulated kidney 5 and simulated ureter 6.

An exemplary PCNL simulation is now discussed referencing FIG. 1 and FIG. 3, which is a side view of the medical demonstration and training model 1 taken at cross-section 3-3 of FIG. 1. FIG. 3 illustrates that renal sheath 11 may be placed into one of the ports 9 to slide through one of the accessways 7 on the interior of the elastomeric block 3 to reach simulated kidney 5 and demonstrate proper renal sheath placement. Renal sheath 11 may be moved distally to partially enter simulated kidney 5, or may abut simulated kidney 5, providing access to simulated kidney 5 in either example. The model 1 may receive the nephroscope 10 and/or other surgical elements through the placed renal sheath 11 to simulate proper PCNL scope placement. The nephroscope 10 and other surgical elements may then be used to simulate procedures to locate, breakup, and/or remove the at least one kidney stone 19 or renal calculi.

In one example, model 1 may receive the renal sheath 11 through accessway 7, and then receive nephroscope 10 through the placed renal sheath 11. Nephroscope 10 may then be used to locate kidney stone 19 by viewing the distal end of the nephroscope 10 and the placed kidney stone 19 from the exterior of the elastomeric block 3 through the cut portion being left open. An additional element, such as a vacuum or a retrieval basket or grasping forceps (not shown), may be introduced through the nephroscope 10 to remove the located stone.

In another example, model 1 may receive renal sheath 11 through accessway 7 and nephroscope 10 through renal sheath 11. Nephroscope 10 may include a camera (not shown) at a distal end or another viewing apparatus. Here, the cut portion of elastomeric block 3 has been pressed back into elastomeric block 3 such that simulated kidney 5 and simulated ureter 6 are only visible through the viewing apparatus associated with nephroscope 10. The placed kidney stone 19 may be located with the viewing apparatus associated with nephroscope 10. Then, an additional removal element like a vacuum or retrieval device may be introduced through nephroscope 10 to remove the located stone.

In a further aspect of the invention, model 1 may receive renal sheath 11 through accessway 7 and nephroscope 10 through renal sheath 11. The placed kidney stone 19 may be located with nephroscope 10 through any technique, and the kidney stone 19 may too large to retrieve in whole. As such, a lithotripter (not shown) may be introduced through nephroscope 10 such that the kidney stone 19 may be broken up by the ultrasound waves or laser beam of the lithotripter before being removed by a vacuum or retrieval device. The water or solution in setup container 20 that also penetrates simulated kidney 5 and simulated ureter 6 ensures that the kidney stone 19 mimics the movement of a kidney stone in a PCNL procedure during the lithotripsy simulation.

Alternatively, model 1 may receive a thinner and/or more flexible scope (not shown) that is introduced through the placed renal sheath 11, where the scope comprises a camera at its distal end to locate the at least one kidney stone 19. Once the stone is located, nephroscope 10 may be inserted through renal sheath 11 and into simulated kidney 5 to the determined location of the kidney stone 19 to remove the stone with a vacuum or other retrieval device. A lithotripter may also be used as discussed above if the stone's size necessitates lithotripsy before removal.

The exemplary renal calyx model 12 may take sizes, shapes, and configurations different from that shown in FIG. 2 to represent, and thus allow demonstration and training with different sizes, shapes, and configurations of simulated kidney 5. Because patients and PCNL procedures vary, a different medical demonstration and training model 1 may be formed by modifying the renal calyx model 12 that is used to form the simulated kidney 5 of the elastomeric block 3.

Similarly, in another aspect of the invention, the at least one kidney stone 19 may be different sizes, shapes, and configurations to represent different types of kidney stones that are extracted or broken up in a PCNL procedure. The at least one kidney stone 19 may also be selectively manufactured by mixing plaster powder with water in varying proportions to vary the hardness of the resulting stone and may be placed in varying molds to form varying shapes and sizes. The mixture may also be pressurized or placed in a vacuum for a period of time to increase the hardness, or may be frequently whipped to form an airier or less dense stone.

The inserted kidney stone or stones 19 may also be inserted into different locations throughout the simulated kidney 5 and simulated ureter 6 of the elastomeric block 3. Once removed as part of the simulation, the at least one kidney stone 19 may be reinserted into the model 1 by simply peeling back the portion of elastomeric block 3 that covers the simulated kidney 5, if elastomeric block 3 was closed for the simulation. As such, the demonstration or training procedure may be quickly repeated or modified to allow efficient demonstrations or trainings.

Moreover, different kidney stones may be inserted into different locations in the simulated kidney 5 and simulated ureter 6 in the elastomeric block 3, presenting varying procedures of differing difficulties or complications. For example, in one simulation, a medical professional could practice inserting renal sheath 11, nephroscope 10, and a lithotripter and locating, breaking up, and removing a calyceal kidney stone in one of the calyces 16. Then, almost immediately after, the medical professional could simulate inserting renal sheath 11, nephroscope 10, and a lithotripter and locating, breaking up, and removing a renal pelvic stone in renal pelvis 18 or a ureteral stone in simulated ureter 6 using the same demonstration and training model 1. As a result, the demonstration and training model 1 may be used to simulate a variety of situations that necessitate a PCNL procedure, as well as be used to train medical professionals on placing a renal sheath and performing percutaneous nephrolithotomy or percutaneous nephrolithotripsy.

While principles of the present disclosure are described herein with reference to illustrative examples for particular applications, it should be understood that the disclosure is not limited thereto. Those having ordinary skill in the art and access to the teachings provided herein will recognize additional modifications, applications, embodiments, and substitution of equivalents all fall within the scope of the features described herein. Accordingly, the claimed features are not to be considered as limited by the foregoing description.

We claim:

1. A medical training model, comprising:
an elastomeric block having internal structures, the internal structures including
a simulated kidney, and
at least one accessway extending from an external surface of the elastomeric block to the simulated kidney.

2. The medical training model of claim 1, wherein the simulated kidney includes a renal pelvis, calyces, and lower, middle, and upper kidney poles.

3. The medical training model of claim 1, wherein the internal structures further includes a simulated ureter.

4. The medical training model of claim 1, wherein the internal structures further includes a simulated stone.

5. The medical training model of claim 1, wherein the simulated kidney is completely enclosed within the elastomeric block, and
wherein the elastomeric block is a molded elastomeric block.

6. The medical training model of claim 1, wherein the simulated kidney is open to a front face of the elastomeric block.

7. The medical training model of claim 1, further including an angled block support receiving the elastomeric block in a tilted orientation.

8. The medical training model of claim 1, further including an angled block support receiving the elastomeric block in a tilted orientation, wherein a liquid-tight container receives the elastomeric block on the angled block support.

9. The medical training model of claim 1, wherein the elastomeric block is formed of one of casting resin, silicone, P-15 silicone, or a solid forming liquid molding formula.

10. The medical training model of claim 1, wherein the at least one accessway includes at least three accessways, and
wherein the at least three accessways extend from the external surface of the elastomeric block to at least a lower pole, a middle pole, and a upper pole of the simulated kidney.

11. A medical training model, comprising:
an elastomeric block having internal structures, the internal structures including a simulated kidney; and
a liquid-tight container receiving the elastomeric block in a tilted orientation.

12. The medical training model of claim 11, further comprising at least one accessway extending from an external surface of the elastomeric block to the simulated kidney.

13. The medical training model of claim 12, further including a sheath extending outside the elastomeric block, into the at least one accessway, and to the simulated kidney.

14. The medical training model of claim 11, wherein the tilted orientation is approximately 30 degrees from horizontal.

15. A medical training method, comprising:
inserting a medical device into an internal structure formed in an elastomeric block, the internal structure including at least one of a simulated kidney or a simulated ureter; and
locating a stone in the internal structure with the medical device.

16. The medical training method of claim 15, further including retrieving the stone from the internal structure.

17. The medical training method of claim 16, further including reintroducing a stone to the internal structure after retrieval.

18. The medical training method of claim 15, further including introducing a sheath from external to the elastomeric block to the internal structure, and wherein the inserting of the medical device includes inserting the medical device through the sheath.

19. The medical training method of claim 15, wherein the internal structure is filled with liquid, and the method further includes applying energy to the stone.

20. The medical training method of claim 15, wherein locating the stone includes viewing the stone through the medical device.
